(19) United States
(12) Patent Application Publication
(10) Pub. No.: US 2019/0310510 A1
(43) Pub. Date: Oct. 10, 2019

(54) LIQUID CRYSTAL PANEL AND LIQUID CRYSTAL DISPLAY DEVICE

(71) Applicants: HKC Corporation Limited, Shenzhen, Guangdong (CN); Chongqing HKC Optoelectronics Technology Co., Ltd., Chongqing (CN)

(72) Inventor: Chung-Kuang CHIEN, Chongqing (CN)

(21) Appl. No.: 16/461,209

(22) PCT Filed: Jul. 3, 2017
(86) PCT No.: PCT/CN2017/091403

§ 371 Date: May 15, 2019

(30) Foreign Application Priority Data
Dec. 29, 2016 (CN) 201611248032.9

(51) Int. Cl. G02F 1/1335; G02F 1/1339; G02F 1/1337

(52) U.S. Cl. CPC G02F 1/133514; G02F 1/1337; G02F 1/1339; G02F 1/133512

(57) ABSTRACT

A liquid crystal panel and a liquid crystal display device are disclosed. The liquid crystal panel includes a color filter substrate, which includes a substrate, a black matrix disposed on the substrate, and a first slot disposed on the black matrix. The first slot penetrates through the black matrix. A bottom surface of the first slot is the substrate, and a black seal is disposed on the first slot.

### BACKGROUND

### Technology Field

The present disclosure relates to a display technology field and, in particular, to a liquid crystal panel and a liquid crystal display device.

### Description of Related Art

The liquid crystal display has many advantages, such as the thin body, low power consumption, and no radiation, and is widely applied. Most of the liquid crystal displays available in the market are backlight type liquid crystal displays each including a liquid crystal panel and a backlight module. The working principle of the liquid crystal panel is to place the liquid crystal between two parallel glass substrates, and to apply a driving voltage to the two glass substrates to control the orientation of the liquid crystal, and refract the light emitted from the backlight module to generate an image frame.

The thin-film-transistor liquid crystal display (TFT-LCD) has the properties including the low power consumption, excellent frame quality and higher production yield, and has gradually become the most popular product in the display field. Similarly, the TFT-LCD includes a liquid crystal panel and a backlight module. The liquid crystal panel includes a color filter substrate (CF substrate) and a thin-film-transistor substrate (TFT substrate). The opposite inner sides of the above substrates are configured with transparent electrodes, respectively. A layer of liquid crystal (LC) is interposed between the two substrates. The liquid crystal panel controls the orientation of the liquid crystal through the electric field to change the polarization state of light, and a polarizer is adopted to implement the transmission and obstruction of the light path and thus the displaying objectives.

In the conventional manufacturing processes, the CF substrate is formed by the processes of photoresist coating, exposing, developing, and forming the ITO, photo spacer (PS) and the like. When the seal (or sealant) and the black matrix are tested in the peeling strength test or PCT test, the peeling of the black matrix often tends to occur.

### SUMMARY

This disclosure is to provide a liquid crystal panel capable of enhancing an adhesive force of a seal.

In addition, this disclosure further provides a liquid crystal display device using the liquid crystal panel.

The disclosure provides a liquid crystal panel including a color filter substrate, which includes a substrate, a black matrix and a first slot. The black matrix is disposed on the substrate, and the first slot is disposed on the black matrix. The first slot penetrates through the black matrix. A bottom surface of the first slot is the substrate, and a black seal is disposed on the first slot.

The first slot continuously surrounds a black seal covering region. The continuous slot can significantly increase the contact surface area between the seal and the substrate.

The first slot is discontinuously disposed along the black seal covering region. The black seal not only increases the contact surface area with the substrate, but also has the very good connection with the black matrix.

The first slot comprises a plurality of first sub-slots disconnected from each other and disposed around the black matrix. One or more first sub-slots may be provided in the upper, lower, left and right directions of a display area, or first sub-slots may be provided at four corners. The processing of the first slot is simple and convenient, and the contact surface area between the black seal and the substrate is increased.

The color filter substrate further comprises an alignment layer, the alignment layer is disposed on the black matrix, and a stopper obstructing the alignment layer is disposed inside the first slot of the black matrix. The alignment layer spreads out and overlaps with the black seal to affect the effect of the black seal, and the stopper is used to stop the alignment layer from spreading out.

The stopper is a second slot. The stopper may be the second slot formed on the black matrix.

An opening of the second slot is covered with a light-obstructing layer, and the light-obstructing layer and the black seal have the same material. The second slot further penetrates through the black matrix to cause the light leakage, and a light-obstructing layer is coated to prevent the light leakage. The light-obstructing layer and the black seal have the same material and can be implemented when the black seal is provided without the additional material, so that the purchase cost and purchase amount are decreased, and errors cannot easily occur. If the second slot is a blind slot, its bottom portion is still the black matrix without the light leakage, but the thickness of the black matrix is decreased. The light-obstructing layer further covers the top surface thereof to achieve the better effect.

The stopper is a boss. The stopper may be a blocking boss disposed on the black matrix. If the middle height of the black matrix is higher than the heights of two sides thereof, and the outer height of the black matrix is higher than the inner height thereof, then an inner seal for obstructing the alignment layer from spreading may further be disposed inside the black seal. Thus, the apparatus needs not to be replaced, and it is only necessary to dispose one ring inside the normal black seal.

The liquid crystal panel further includes a backlight module. An array substrate is disposed on the backlight module, and the array substrate and the color filter substrate are disposed opposite to each other. The color filter substrate is connected to the array substrate through the black seal. A color filter layer staggered with the black matrix is further disposed on the color filter substrate. A liquid crystal and a PS are provided between the array substrate and the color filter substrate. A thin film transistor or thin film transistors are disposed on the array substrate, and the color filter layer, the liquid crystal, the PS and the thin film transistor or transistors are disposed within the black seal.

According to another aspect of this disclosure, this disclosure also provides a liquid crystal display device including any of the above-mentioned liquid crystal panel.

The black matrix is formed with the first slot, the bottom surface of the first slot is the substrate, and the black seal is disposed on the first slot. In this manner, the black seal and the black matrix connected together on one side can be directly connected to the substrate, and the contact surface area between the black seal and the substrate is increased. The adhesive force of the black seal to the substrate is far greater than the adhesive force of the black seal to the black matrix. Since the first slot formed on the black matrix causes the light leakage, the black seal is used and coated to prevent the light leakage. Thus, the black seal can adhere the color filter substrate and the array substrate together in a good manner, thereby enhancing the connection strength between the black seal and the black matrix, and enhancing structural strength in the PCT and peeling tests.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1a is a schematic view showing an ordinary seal;

FIG. 1b is a schematic view showing a black seal;

FIG. 2 is a partial schematic view showing a liquid crystal panel according to an embodiment of this disclosure;

FIG. 3 is a partial schematic structure view showing a color filter substrate according to the embodiment of this disclosure;

FIG. 4 is a schematic view showing the slot and the black seal on the black matrix according to the embodiment of this disclosure;

FIG. 5 is another schematic view showing the partial structure of the color filter substrate according to the embodiment of this disclosure;

FIG. 6 is another schematic view showing the slot and the black seal on the black matrix according to the embodiment of this disclosure; and

FIG. 7 is still another schematic view showing the partial structure of the color filter substrate according to the embodiment of this disclosure.

### DETAILED DESCRIPTION OF THE DISCLOSURE

Specific structures and function details disclosed herein are only for the illustrative purpose for describing the exemplary embodiment of this disclosure. However, this disclosure can be specifically implemented through many replacements, and should not be explained as being restricted to only the embodiment disclosed herein.

In the description of this disclosure, it is to be understood that the terms “center”, “transversal”, “up,” “down,” “left,” “right,” “vertical”, “horizontal”, “top,” “bottom,” “inside” and “outside” indicating the orientation or position relationships are the orientation or position relationships based on the drawing, are only provided for the purposes of describing this disclosure and simplifying the description, but do not indicate or imply that the directed devices or elements must have the specific orientations or be constructed and operated in the specific orientations, and thus cannot be understood as the restriction to this disclosure. In addition, the terms “first,” and “second” are used for the illustrative purpose only and cannot be understood as indicating or implying the relative importance or implicitly specifying the number of indicated technical features. Therefore, the features restricted by “first” and “second” may expressly or implicitly comprise one or multiple ones of the features. In the description of this disclosure, unless otherwise described, the meaning of “multiple” comprises two or more than two. In addition, the terms “comprises” and any modification thereof intend to cover the non-exclusive inclusions.

In the description of this disclosure, it needs to be described that, unless otherwise expressly stated and limited, the terms “mount,” “link” and “connect” should be broadly understood. For example, they may be the fixed connection, may be the detachable connection or may be the integral connection; may be the mechanical connection or may also be the electrical connection; or may be the direct connection, may be the indirect connection through a middle medium or may be the inner communication between two elements. It will be apparent to those skilled in the art that the specific meanings of the above terms in this application may be understood according to the specific conditions.

The terms used herein are for the purpose of describing only specific embodiments and are not intended to limit the exemplary embodiments. Unless the contexts clearly indicate otherwise, the singular form “one,” “a” and “an” used here further intend to include plural forms. It should also be understood that the terms “comprising” and/or “including” are used herein to describe the features to describe the presence of stated features, integers, steps, operations, units and/or elements without excluding the presence or addition of one or more other features, integers, steps, operations, units, elements, and/or combinations thereof.

This disclosure will be described in detail according to the preferred embodiment with reference to the drawings.

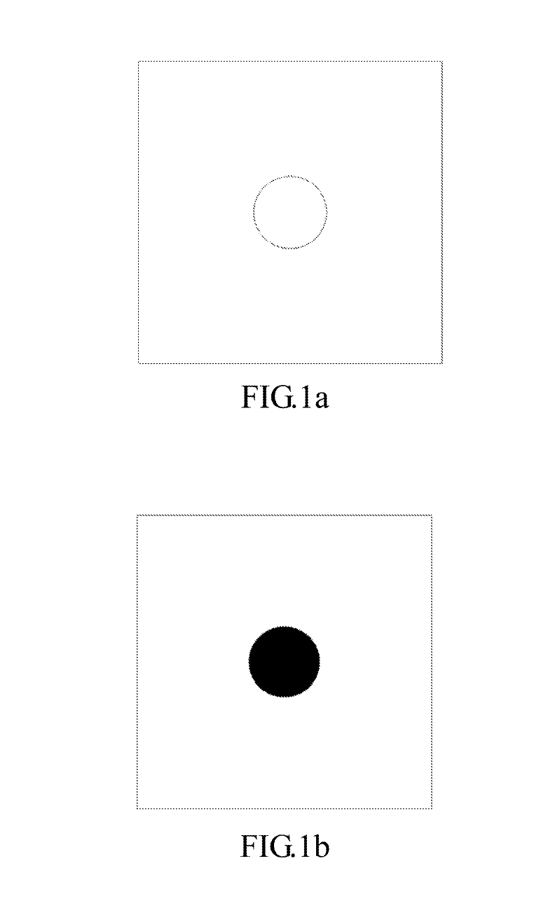

As shown in FIGS. 1a and 1b, two heat auxiliary curable materials are applied, wherein symbol 1a represents the transparent seal, and symbol 1b represents the black seal. Compared with the ordinary transparent seal, the black seal has the light-obstructing effect, wherein the black seal has the optical density OD 5 um/2.5, and the BM has the optical density OD ranging from about 4 to 5.

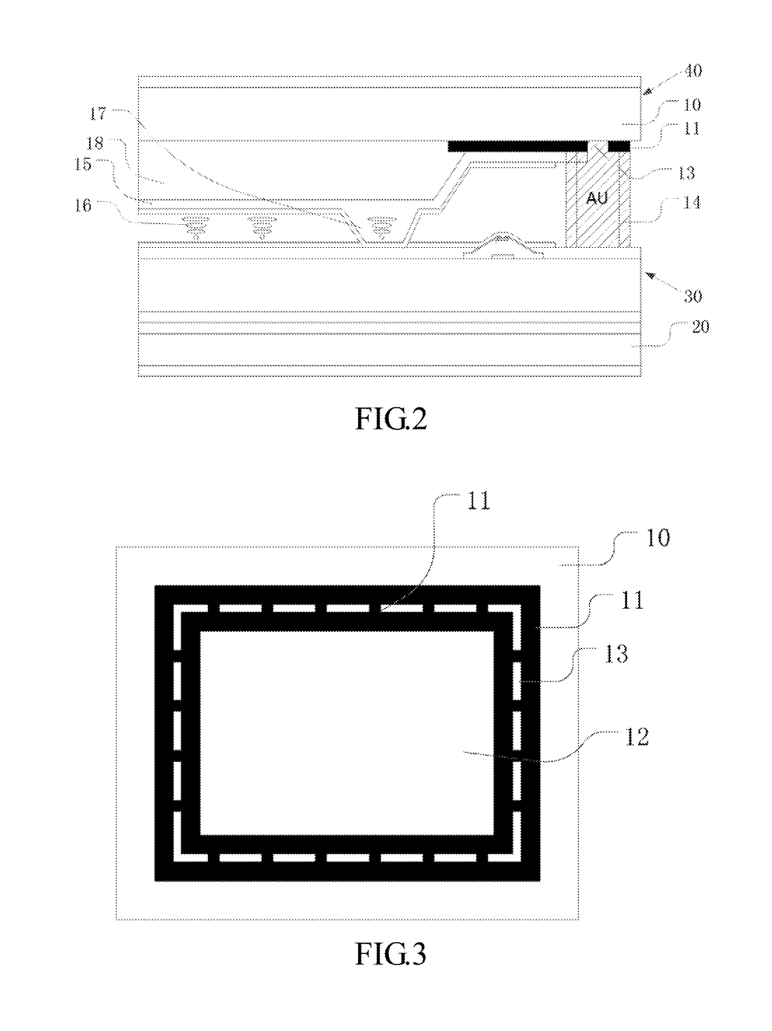

In the embodiment shown in FIG. 2, a liquid crystal panel comprises an array substrate 30 and a color filter substrate 40. The array substrate 30 and the color filter substrate 40 are disposed opposite to each other. The color filter substrate 40 is connected to the array substrate 30 through a black seal 14. A color filter layer 18 staggered with a black matrix 11 is further disposed on the color filter substrate 40. A liquid crystal 16 and a photo spacer (PS) 17 are provided between the array substrate 30 and the color filter substrate 40. A thin film transistor or thin film transistors are disposed on the array substrate 30. The color filter layer 18, the liquid crystal 16, the photo spacer (PS) 17 and the thin film transistor(s) are disposed within the black seal 14. Of course, the liquid crystal panel may further comprise a backlight module 20, the array substrate 30 is disposed on a back cover module 19, and the array substrate 30 and the color filter substrate 40 are disposed opposite to each other. A substrate 10 may be made of the glass material, the plastic material or the like.

In the embodiment shown in FIGS. 2 and 3, the color filter substrate comprises the substrate 10, the black matrix 11 and a first slot 13. The black matrix 11 is disposed on the substrate 10, the first slot 13 is disposed on the black matrix 11, the first slot 13 penetrates through the black matrix 11, a bottom surface of the first slot 13 is the substrate 10, and the black seal 14 is disposed on the first slot 13.

In this embodiment, the black matrix 11 is formed with the first slot, the bottom surface of the first slot is the substrate 10, and the black seal 14 is disposed on the first slot 13. In this manner, the black seal 14 and the black matrix 11 connected together on one side can be directly connected to the substrate 10, and the contact surface area between the black seal 14 and the substrate 10 is increased. The adhesive force of the black seal 14 to the substrate 10 is far greater than the adhesive force of the black seal 14 to the black matrix 11. Since the first slot 13 formed on the black matrix 11 causes the light leakage, the black seal 14 is coated to prevent the light leakage. Thus, the black seal 14 can adhere the color filter substrate and the array substrate together in a good manner, thereby enhancing the connection strength between the black seal 14 and the black matrix 11 and enhancing the structural strength in the PCT and peeling tests. In addition, the black seal 14 designed on the narrow border must fall on the black matrix (BM) 11. Also, the FSA process UV lamp needs the UV mask, or otherwise the visible glue needs to be applied, and the process is somewhat difficult to affect the strengthening of the black seal 14. At present, a slot is formed on the black matrix II (BM) of the color filter substrate (CF) to avoid the problem, and further to decrease the process restriction. The UV curing of the black seal may be illuminated from the array substrate on the TFT side, and may also be illuminated from the color filter substrate (CF) side, wherein the narrow border curing is made by the illumination on the CF side, and the problem that the shadow portion is not sufficiently cured can be reduced.

In addition to the original properties of the seal, the black seal further has the transmittance thereof to achieve the light-obstructing effect, it is preferred to achieve the same light-obstructing effect as the black matrix, and the shadow portion curing property of the black seal is consistent with or close to the general glue. The process and jig for the liquid crystal panel are adjusted according to the black seal to satisfy various parameter indicators of the liquid crystal panel.

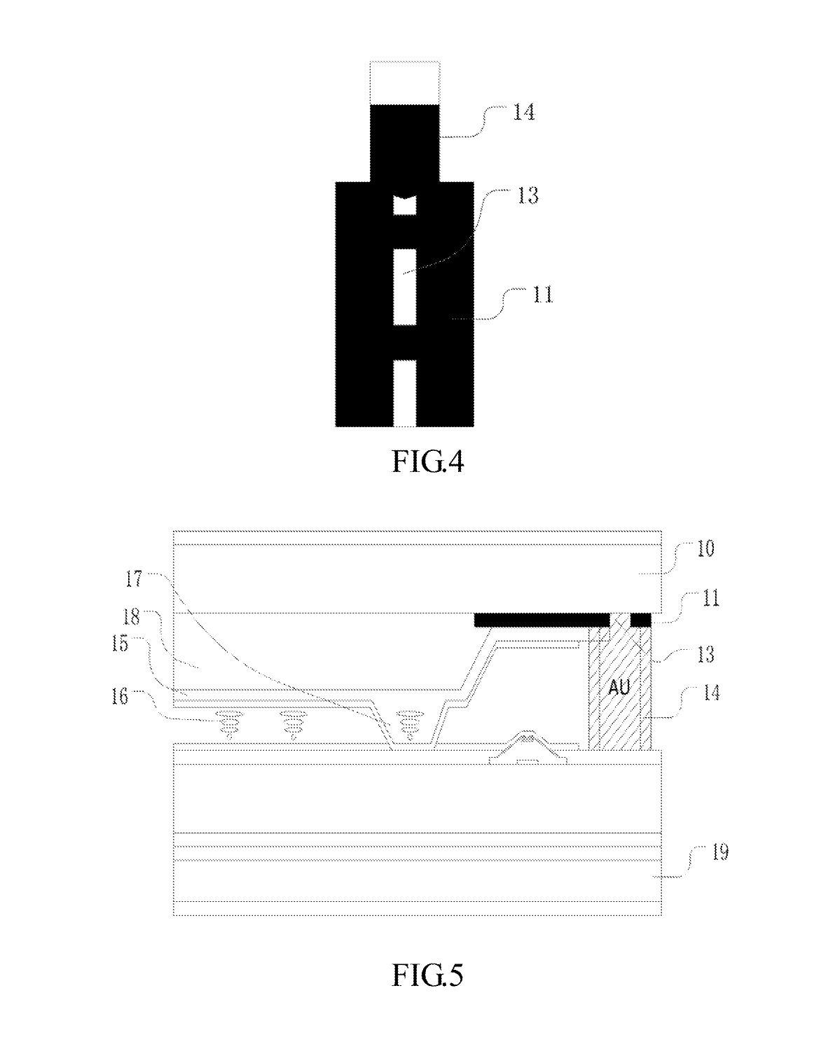

In the embodiment shown in FIGS. 2 to 4, the liquid crystal panel comprises the array substrate 30 and the color filter substrate 40. The array substrate 30 and the color filter substrate 40 are disposed opposite to each other. The color filter substrate 40 is connected to the array substrate 30 through the black seal 14. The color filter layer 18 staggered with the black matrix II is further disposed on the color filter substrate 40. The liquid crystal 16 and the photo spacer (PS) 17 are provided between the array substrate 30 and the color filter substrate 40. The thin film transistor or transistors are disposed on the array substrate 30. The color filter layer 18, the liquid crystal 16, the photo spacer (PS) 17 and the thin film transistor are disposed within the black seal 14. Of course, the liquid crystal panel may further comprise the backlight module 20, the array substrate 30 is disposed on the back cover module 19, and the array substrate 30 and the color filter substrate 40 are disposed opposite to each other. The substrate 10 may be made of the glass material, the plastic material or the like.

As shown in FIGS. 2 and 3, the color filter substrate includes a substrate 10, a black matrix 11 and a first slot 13. The black matrix 11 is disposed on the substrate 10, the first slot 13 is disposed on the black matrix 11, the first slot 13 penetrates through the black matrix 11, a bottom surface of the first slot 13 is the substrate 10, and the black seal 14 is disposed on the first slot 13.

The first slot 13 is discontinuously disposed along the covering region of the black seal 14. The black seal 14 not only increases the contact surface area with the substrate 10, but also has the very good connection with the black matrix 11. Consequently, the contact surface area between the black seal 14 and the substrate 10 (e.g., glass) can be increased by 10% to 20% to increase the structural strength in the panel's PCT/peeling test. The first slot 13 includes a plurality of first sub-slots disconnected from each other and disposed around the black matrix 11. One or more first sub-slots can be provided in the upper, lower, left and right directions of the display area 12, or the first sub-slots can be provided at four corners. The processing of the first slot 13 is simple and convenient, and the contact surface area between the black seal 14 and the substrate 10 is increased.

In the ordinary TV design, the BM CD ranges from about 5000 to 6000 um, the line width of the black seal ranges from about 1200 to 1500 um, and the width of the slot ranges from about 500 to 1000 um. The width of the first slot 13 is smaller than that of the black seal 14. The width of the black seal 14 is limited without affecting the original function of the black seal 14, and the process ability of the line width of the black seal 14 can be enhanced.

In this embodiment, the black matrix 11 is formed with the first slot, the bottom surface of the first slot is the substrate 10, and the black seal 14 is disposed on the first slot. In this manner, the black seal 14 and the black matrix 11 connected together on one side can be directly connected to the substrate 10, and the contact surface area between the black seal 14 and the substrate 10 is increased. The adhesive force of the black seal 14 to the substrate 10 is far greater than the adhesive force of the black seal 14 to the black matrix 11. Since the first slot formed on the black matrix 11 causes the light leakage, the black seal 14 is coated to prevent the light leakage. Thus, the black seal 14 can adhere the color filter substrate and the array substrate together in a good manner, thereby enhancing the connection strength between the black seal 14 and the black matrix 11 and enhancing the structural strength in the PCT and peeling tests. In addition, the black seal 14 designed on the narrow border must fall on the black matrix (BM) 11. Also, the FSA process UV lamp needs the UV mask, or otherwise the visible glue needs to be applied, and the process is somewhat difficult to affect the strengthening of the black seal 14. At present, a slot is formed on the black matrix 11 (BM) of the color filter substrate (CF) to avoid the problem, and further to decrease the process restriction. The UV curing of the black seal may be illuminated from the array substrate on the TFT side, and may also be illuminated from the color filter substrate (CF) side, wherein the narrow border curing is made by the illumination on the CF side, and the problem that the shadow portion is not sufficiently cured can be reduced.

In addition to the original properties of the seal, the black seal further has the transmittance thereof to achieve the light-obstructing effect, it is preferred to achieve the same light-obstructing effect as the black matrix, and the shadow portion curing property of the black seal is consistent with or close to the general glue. The process and jig for the liquid crystal panel are adjusted according to the black seal to satisfy various parameter indicators of the liquid crystal panel.

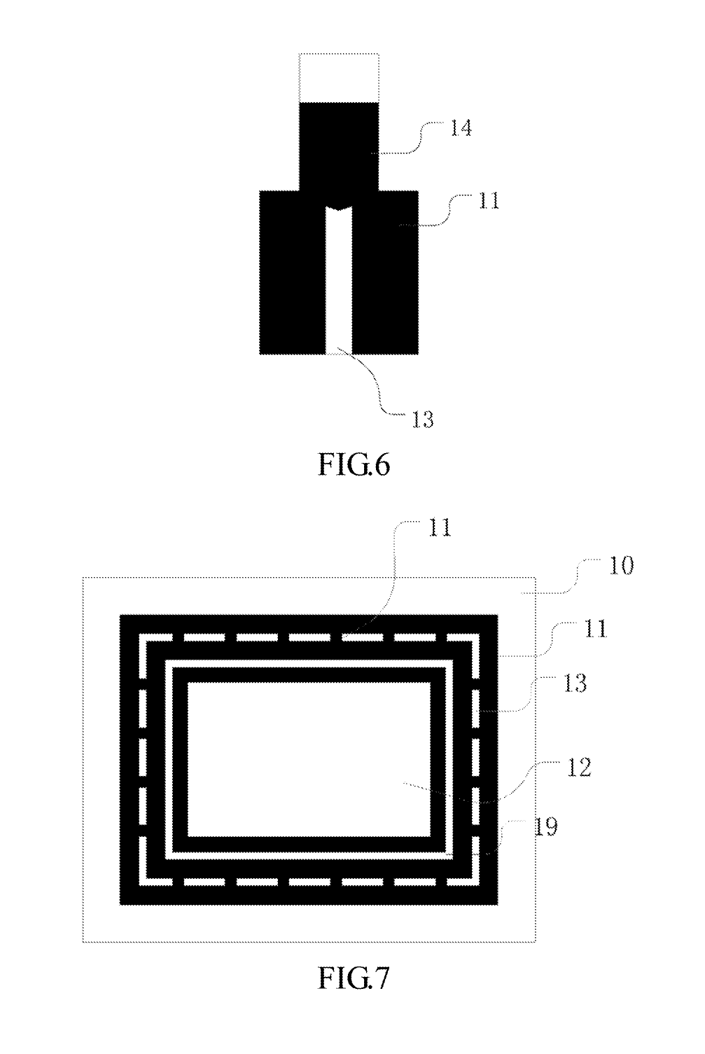

In the embodiment shown in FIGS. 2, 5 and 6, the liquid crystal panel comprises the array substrate 30 and the color filter substrate 40. The array substrate 30 and the color filter substrate 40 are disposed opposite to each other. The color filter substrate 40 is connected to the array substrate 30 through the black seal 14. The color filter layer 18 staggered with the black matrix 11 is further disposed on the color filter substrate 40. The liquid crystal 16 and the photo spacer (PS) 17 are provided between the array substrate 30 and the color filter substrate 40. The thin film transistor or transistors are disposed on the array substrate 30. The color filter layer 18, the liquid crystal 16, the photo spacer (PS) 17 and the thin film transistor are disposed within the black seal 14. Of course, the liquid crystal panel may further comprise the backlight module 20, the array substrate 30 is disposed on the back cover module 19, and the array substrate 30 and the color filter substrate 40 are disposed opposite to each other. The substrate 10 may be made of the glass material, the plastic material or the like.

As shown in FIGS. 2 and 3, the color filter substrate includes a substrate 10, a black matrix 11 and a first slot 13. The black matrix 11 is disposed on the substrate 10, the first slot 13 is disposed on the black matrix 11, the first slot 13 penetrates through the black matrix 11, a bottom surface of the first slot 13 is the substrate 10, and the black seal 14 is disposed on the first slot 13.

The first slot 13 continuously surrounds the covering region of the black seal 14. The first slot 13 is provided around a display area 12. The continuous slot can significantly increase the contact surface area between the black seal 14 and the substrate 10.

In the ordinary TV design, the BM CD ranges from about 5000 to 6000 um, the line width of the black seal ranges from about 1200 to 1500 um, and the width of the slot ranges from about 500 to 1000 um. The width of the first slot 13 is smaller than that of the black seal 14. The width of the black seal 14 is limited without affecting the original function of the black seal 14, and the process ability of the line width of the black seal 14 can be enhanced.

In this embodiment, the black matrix 11 is formed with the first slot, the bottom surface of the first slot is the substrate 10, and the black seal 14 is disposed on the first slot. In this manner, the black seal 14 and the black matrix 11 connected together on one side can be directly connected to the substrate 10, and the contact surface area between the black seal 14 and the substrate 10 is increased. The adhesive force of the black seal 14 to the substrate 10 is far greater than the adhesive force of the black seal 14 to the black matrix 11. Since the first slot formed on the black matrix 11 causes the light leakage, the black seal 14 is coated to prevent the light leakage. Thus, the black seal 14 can adhere the color filter substrate and the array substrate together in a good manner, thereby enhancing the connection strength between the black seal 14 and the black matrix 11 and enhancing the structural strength in the PCT and peeling tests. In addition, the black seal 14 designed on the narrow border must fall on the black matrix (BM) 11. Also, the FSA process UV lamp needs the UV mask, or otherwise the visible glue needs to be applied, and the process is somewhat difficult to affect the strengthening of the black seal 14. At present, a slot is formed on the black matrix 11 (BM) of the color filter substrate (CF) to avoid the problem, and further to decrease the process restriction. The UV curing of the black seal may be illuminated from the array substrate on the TFT side, and may also be illuminated from the color filter substrate (CF) side, wherein the narrow border curing is made by the illumination on the CF side, and the problem that the shadow portion is not sufficiently cured can be reduced.

In addition to the original properties of the seal, the black seal further has the transmittance thereof to achieve the light-obstructing effect, it is preferred to achieve the same light-obstructing effect as the black matrix, and the shadow portion curing property of the black seal is consistent with or close to the general glue. The process and jig for the liquid crystal panel are adjusted according to the black seal to satisfy various parameter indicators of the liquid crystal panel.

In the embodiment shown in FIGS. 2 to 7, the liquid crystal panel comprises the array substrate 30 and the color filter substrate 40. The array substrate 30 and the color filter substrate 40 are disposed opposite to each other. The color filter substrate 40 is connected to the array substrate 30 through the black seal 14. The color filter layer 18 staggered with the black matrix 11 is further disposed on the color filter substrate 40. The liquid crystal 16 and the photo spacer (PS) 17 are provided between the array substrate 30 and the color filter substrate 40. The thin film transistor or transistors are disposed on the array substrate 30. The color filter layer 18, the liquid crystal 16, the photo spacer (PS) 17 and the thin film transistor are disposed within the black seal 14. Of course, the liquid crystal panel may further comprise the backlight module 20, the array substrate 30 is disposed on the back cover module 19, and the array substrate 30 and the color filter substrate 40 are disposed opposite to each other. The substrate 10 may be made of the glass material, the plastic material or the like.

As shown in FIGS. 2 and 3, the color filter substrate includes a substrate 10, a black matrix 11 and a first slot 13. The black matrix 11 is disposed on the substrate 10, the first slot 13 is disposed on the black matrix II, the first slot 13 penetrates through the black matrix 11, a bottom surface of the first slot 13 is the substrate 10, and the black seal 14 is disposed on the first slot 13.

The color filter substrate further comprises an alignment layer 15, the alignment layer 15 is disposed on the black matrix 11, and a stopper 20 obstructing the alignment layer 15 is disposed inside the first slot 13 of the black matrix 11. The alignment layer 15 spreads out and overlaps with the black seal 14 to affect the effect of the black seal 14, and the stopper 20 is used to prevent the alignment layer 15 from spreading out.

The stopper 20 is a second slot. The stopper 20 may be the second slot formed on the black matrix 11. An opening of the second slot is covered with a light-obstructing layer, and the light-obstructing layer and the black seal have the same material 14. The second slot further penetrates through the black matrix 11 to cause the light leakage, and the light-obstructing layer is coated to prevent the light leakage. The light-obstructing layer and the black seal have the same material 14 and can be implemented at the same time when the black seal 14 is provided without the additional material, so that the purchase cost and purchase amount are decreased, and errors cannot easily occur. If the second slot is a blind slot, the bottom portion thereof is still the black matrix 11 without the light leakage. However, the thickness of the black matrix 11 is decreased. The light-obstructing layer further covers the top surface thereof to have the better effect. The stopper 20 may also be a boss. The stopper 20 may be a blocking boss disposed on the black matrix 11. If the middle height of the black matrix 11 is higher than the heights of two sides thereof, and the outer height of the black matrix 11 is higher than the inner height thereof, then an inner seal for obstructing the alignment layer 15 from spreading may further be disposed inside the black seal 14. Thus, the apparatus needs not to be replaced, and it is only necessary to dispose one ring inside the normal black seal 14.

In the ordinary TV design, the BM CD ranges from about 5000 to 6000 um, the line width of the black seal ranges from about 1200 to 1500 um, and the width of the slot ranges from about 500 to 1000 um. The width of the first slot 13 is smaller than that of the black seal 14. The width of the black seal 14 is limited without affecting the original function of the black seal 14, and the process ability of the line width of the black seal 14 can be enhanced.

The first slot 13 is discontinuously disposed along the covering region of the black seal 14. The black seal 14 not only increases the contact surface area with the substrate 10, but also has the very good connection with the black matrix 11. Consequently, the contact surface area between the black seal 14 and the substrate 10 (e.g., glass) can be increased by 10% to 20% to increase the structural strength in the panel's PCT/peeling test.

The first slot 13 continuously surrounds the covering region of the black seal 14. The first slot 13 is provided around a display area 12. The continuous slot can significantly increase the contact surface area between the black seal 14 and the substrate 10. The first slot 13 may further comprise a plurality of first sub-slots disconnected from each other and disposed around the black matrix. One or more first sub-slots may be provided in the upper, lower, left and right directions of the display area 12, or first sub-slots may be provided at four corners. The processing of the first slot is simple and convenient, and the contact surface area between the black seal 14 and the substrate 10 is increased.

In this embodiment, the black matrix 11 is formed with the first slot, the bottom surface of the first slot is the substrate 10, and the black seal 14 is disposed on the first slot. In this manner, the black seal 14 and the black matrix 11 connected together on one side can be directly connected to the substrate 10, and the contact surface area between the black seal 14 and the substrate 10 is increased. The adhesive force of the black seal 14 to the substrate 10 is far greater than the adhesive force of the black seal 14 to the black matrix 11. Since the first slot formed on the black matrix 11 causes the light leakage, the black seal 14 is coated to prevent the light leakage. Thus, the black seal 14 can adhere the color filter substrate and the array substrate together in a good manner, thereby enhancing the connection strength between the black seal 14 and the black matrix 11 and enhancing the structural strength in the PCT and peeling tests. In addition, the black seal 14 designed on the narrow border must fall on the black matrix (BM) 11. Also, the FSA process UV lamp needs the UV mask, or otherwise the visible glue needs to be applied, and the process is somewhat difficult to affect the strengthening of the black seal 14. At present, a slot is formed on the black matrix 11 (BM) of the color filter substrate (CF) to avoid the problem, and further to decrease the process restriction. The UV curing of the black seal may be illuminated from the array substrate on the TFT side, and may also be illuminated from the color filter substrate (CF) side, wherein the narrow border curing is made by the illumination on the CF side, and the problem that the shadow portion is not sufficiently cured can be reduced. The second slot is further formed in the first slot to stop the alignment layer from spreading out and overlapping with the black seal. wherein the first slot and the second slot can be done in easy processes without any additional station and equipment.

In addition to the original properties of the seal, the black seal further has the transmittance thereof to achieve the light-obstructing effect, it is preferred to achieve the same light-obstructing effect as the black matrix, and the shadow portion curing property of the black seal is consistent with or close to the general glue. The process and jig for the liquid crystal panel are adjusted according to the black seal to satisfy various parameter indicators of the liquid crystal panel.

As another embodiment of this disclosure, this embodiment provides a liquid crystal display device comprising a housing. The backlight module, the liquid crystal panel and a control circuit board are provided inside the housing. The backlight module provides a light source, the control circuit board provides a display signal to the liquid crystal panel, and the liquid crystal panel is the liquid crystal panel of the above-mentioned embodiment. The specific structure and connection relationship of the liquid crystal panel can be seen in FIGS. 2 to 7, and detailed descriptions thereof will be omitted.

In the above-mentioned embodiment, the slot may be formed on the black matrix using the half tone mask process. Of course, the slot may also be formed using another process.

In the above-mentioned embodiment, the color filter substrate may include a TFT array, and the color filter layer and the TFT array can be formed on the same substrate.

In the above-mentioned embodiment, the liquid crystal panel of the disclosure can be a curved panel.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A liquid crystal panel comprising a color filter substrate, the color filter substrate comprising:
a substrate;
a black matrix disposed on the substrate; and
a first slot disposed on the black matrix, the first slot penetrating through the black matrix, wherein a bottom surface of the first slot is the substrate, and a black seal is disposed on the first slot;
wherein the first slot continuously surrounds a black seal covering region; or the first slot is discontinuously disposed along the black seal covering region; or
the first slot comprises a plurality of first sub-slots disconnected from each other and disposed around the black matrix;
wherein the color filter substrate further comprises an alignment layer, the alignment layer is disposed on the black matrix, and a stopper obstructing the alignment layer is disposed inside the first slot of the black matrix;
wherein the stopper is a second slot, an opening of the second slot is covered with a light-obstructing layer, and the light-obstructing layer and the black seal have the same material; or the stopper is a boss; and
wherein the liquid crystal panel further comprises a backlight module, an array substrate is disposed on the backlight module, the array substrate and the color filter substrate are disposed opposite to each other, the color filter substrate is connected to the array substrate through the black seal, a color filter layer staggered with the black matrix is further disposed on the color filter substrate, a liquid crystal and a photo spacer (PS) are provided between the array substrate and the color filter substrate, a thin film transistor or thin film transistors are disposed on the array substrate, and the color filter layer, the liquid crystal, the PS and the thin film transistor or transistors are disposed within the black seal.

2. A liquid crystal panel comprising a color filter substrate, the color filter substrate comprising:
a substrate;
a black matrix disposed on the substrate; and
a first slot disposed on the black matrix, the first slot penetrating through the black matrix, wherein a bottom surface of the first slot is the substrate, and a black seal is disposed on the first slot.

3. The liquid crystal panel according to claim 2, wherein the first slot continuously surrounds a black seal covering region.

4. The liquid crystal panel according to claim 2, wherein the first slot is discontinuously disposed along the black seal covering region.

5. The liquid crystal panel according to claim 2, wherein the first slot comprises a plurality of first sub-slots disconnected from each other and disposed around the black matrix.

6. The liquid crystal panel according to claim 2, wherein the color filter substrate further comprises an alignment layer, the alignment layer is disposed on the black matrix, and a stopper obstructing the alignment layer is disposed inside the first slot of the black matrix.

7. The liquid crystal panel according to claim 6, wherein the stopper is a second slot.

8. The liquid crystal panel according to claim 2, wherein the color filter substrate further comprises an alignment layer, the alignment layer is disposed on the black matrix, a stopper obstructing the alignment layer is disposed inside the first slot of the black matrix, and the stopper is a second slot.

9. The liquid crystal panel according to claim 7, wherein an opening of the second slot is covered with a light-obstructing layer, and the light-obstructing layer and the black seal have the same material.

10. The liquid crystal panel according to claim 6, wherein the stopper is a second slot, an opening of the second slot is covered with a light-obstructing layer, and the light-obstructing layer and the black seal have the same material.

11. The liquid crystal panel according to claim 2, wherein the color filter substrate further comprises an alignment layer, the alignment layer is disposed on the black matrix, a stopper obstructing the alignment layer is disposed inside the first slot of the black matrix, the stopper is a second slot, an opening of the second slot is covered with a light-obstructing layer, and the light-obstructing layer and the black seal have the same material.

12. The liquid crystal panel according to claim 6, wherein the stopper is a boss.

13. The liquid crystal panel according to claim 2, wherein the color filter substrate further comprises an alignment layer, the alignment layer is disposed on the black matrix, a stopper obstructing the alignment layer is disposed inside the first slot of the black matrix, and the stopper is a boss.

14. The liquid crystal panel according to claim 2, wherein the first slot continuously surrounds a black seal covering region, the color filter substrate further comprises an alignment layer, the alignment layer is disposed on the black matrix, a stopper obstructing the alignment layer is disposed inside the first slot of the black matrix; and
wherein the stopper is a second slot, an opening of the second slot is covered with a light-obstructing layer, and the light-obstructing layer and the black seal have the same material; or the stopper is a boss.

15. The liquid crystal panel according to claim 2, wherein the first slot is discontinuously disposed along a black seal covering region, the color filter substrate further comprises an alignment layer, the alignment layer is disposed on the black matrix, and a stopper obstructing the alignment layer is disposed inside the first slot of the black matrix;
wherein the stopper is a second slot, an opening of the second slot is covered with a light-obstructing layer, and the light-obstructing layer and the black seal have the same material; or the stopper is a boss.

16. The liquid crystal panel according to claim 2, wherein the first slot comprises a plurality of first sub-slots disconnected from each other and disposed around the black matrix, the color filter substrate further comprises an alignment layer, the alignment layer is disposed on the black matrix, and a stopper obstructing the alignment layer is disposed inside the first slot of the black matrix; and
wherein the stopper is a second slot, an opening of the second slot is covered with a light-obstructing layer, and the light-obstructing layer and the black seal have the same material; or the stopper is a boss.

17. The liquid crystal panel according to claim 2, wherein the liquid crystal panel further comprises a backlight module, an array substrate is disposed on the backlight module, the array substrate and the color filter substrate are disposed opposite to each other, the color filter substrate is connected to the array substrate through the black seal, a color filter layer staggered with the black matrix is further disposed on the color filter substrate, a liquid crystal and a photo spacer (PS) are provided between the array substrate and the color filter substrate, a thin film transistor or thin film transistors are disposed on the array substrate, and the color filter layer, the liquid crystal, the PS and the thin film transistor or transistors are disposed within the black seal.

18. The liquid crystal panel according to claim 2, wherein the first slot continuously surrounds a black seal covering region; or the first slot is discontinuously disposed along the black seal covering region; or the first slot comprises a plurality of first sub-slots disconnected from each other and disposed around the black matrix;
the color filter substrate further comprises an alignment layer, the alignment layer is disposed on the black matrix, and a stopper obstructing the alignment layer is disposed inside the first slot of the black matrix;
the stopper is a second slot, an opening of the second slot is covered with a light-obstructing layer, and the light-obstructing layer and the black seal have the same material; or the stopper is a boss; and
the liquid crystal panel further comprises a backlight module, an array substrate is disposed on the backlight module, the array substrate and the color filter substrate are disposed opposite to each other, the color filter substrate is connected to the array substrate through the black seal, a color filter layer staggered with the black matrix is further disposed on the color filter substrate, a liquid crystal and a photo spacer (PS) are provided between the array substrate and the color filter substrate, a thin film transistor or thin film transistors are disposed on the array substrate, and the color filter layer, the liquid crystal, the PS and the thin film transistor or transistors are disposed within the black seal.

19. A liquid crystal display device comprising a liquid crystal panel, the liquid crystal panel comprising a color filter substrate, the color filter substrate comprising:
a substrate;
a black matrix disposed on the substrate; and
a first slot disposed on the black matrix, the first slot penetrating through the black matrix, wherein a bottom surface of the first slot is the substrate, and a black seal is disposed on the first slot.

20. The liquid crystal display device according to claim 19, wherein:
the first slot continuously surrounds a black seal covering region; or the first slot is discontinuously disposed along the black seal covering region; or the first slot comprises a plurality of first sub-slots disconnected from each other and disposed around the black matrix;
the color filter substrate further comprises an alignment layer, the alignment layer is disposed on the black matrix, and a stopper obstructing the alignment layer is disposed inside the first slot of the black matrix;
the stopper is a second slot, an opening of the second slot is covered with a light-obstructing layer, and the light-obstructing layer and the black seal have the same material; or the stopper is a boss; and
the liquid crystal panel further comprises a backlight module, an array substrate is disposed on the backlight module, the array substrate and the color filter substrate are disposed opposite to each other, the color filter substrate is connected to the array substrate through the black seal, a color filter layer staggered with the black matrix is further disposed on the color filter substrate, a liquid crystal and a photo spacer (PS) are provided between the array substrate and the color filter substrate, a thin film transistor or thin film transistors are disposed on the array substrate, and the color filter layer, the liquid crystal, the PS and the thin film transistor or transistors are disposed within the black seal.
